(19) United States
(12) Patent Application Publication
(10) Pub. No.: US 2017/0332752 A1
(43) Pub. Date: Nov. 23, 2017

(54) TRAVEL BAG

(71) Applicant: Judith MCGINLEY, Alexandria, VA (US)

(72) Inventor: Judith MCGINLEY, Alexandria, VA (US)

(21) Appl. No.: 15/439,063

(22) Filed: Feb. 22, 2017

Related U.S. Application Data
(60) Provisional application No. 62/338,005, filed on May 18, 2016.

(51) Int. Cl. A45C 3/00; B60N 2/44; A45C 13/10; A45C 13/12

(52) U.S. Cl. CPC A45C 3/00; A45C 13/123; B60N 2/44; A45C 13/103; A45C 2013/1015; A45C 2003/008

(57) ABSTRACT

A travel bag having a front panel connected to a rear panel to define an interior space therebetween with a top opening. A front flap is secured to the rear panel near the top opening by a flexible connection for pivotal movement relative thereto. The front flap has an inner face and an outer face defining an internal pocket therebetween, with the inner face having an opening into the internal pocket. The front flap is movable to a closed position over the front panel to close the travel bag. The front flap is movable to an open position over the rear panel to open the travel bag and expose the inner face of the front flap and the opening into the internal pocket.

### CROSS REFERENCE TO RELATED APPLICATION

The present application claims the priority of Provisional Application No. 62/338,005 filed on May 18, 2016.

### BACKGROUND OF THE INVENTION

The present invention relates to a travel bag that can be positioned in a seat pocket in the rear of an airline or train seat or the like so that an opening to the internal pocket in a front flap of the bag can be accessed by a passenger behind the seat pocket.

Airlines, trains, buses, ferries and other transportation vehicles generally restrict the amount of luggage that passengers can access during travel. Even luggage that can be carried on board are inaccessible during travel because regulations require the storage of carryon luggage to overhead bins and under the seats. Consequently, the traveling public is often greatly inconvenienced because the only accessible luggage during travel is what would fit in the limited space inside a seat pocket in front of the passenger. There are many items that may be essential or convenient and whose access may be desired constantly throughout travels including, for example, medication, glasses, small medical devices, tissue, phones, headphones, books, pens, batteries and the like.

The seat pocket is not an ideal storage location because it tends to be small, and already filled with materials such as magazines, evacuation instructions, menus and the like. Also, seat pockets may be made from netting or have holes in the bottom by design for easier cleaning. These netting or holes allow smaller items such as pill packages and pens to fall through. If a passenger transfers his possessions into the seat pocket, there is a risk that in the rush of travel, the possessions would be lost, fall through the netting, misplaced or at least not easily available during travel. This problem is especially acute if a journey requires flight changes or changes in modes of transportation.

### SUMMARY OF THE INVENTION

The present invention is directed to a travel bag which, when installed in a seat pocket, solves the aforementioned deficiencies of the seat pocket. The need for a removable travel bag which can be easily and securely installed in a seat pocket and allow convenient and simultaneous access to the contents within the interior space of the travel bag and the contents within the interior pocket of the front flap is satisfied by the travel bag as described. It is a further object to provide an improved travel bag which is easy to carry, which fits into the seat pocket in front of the passenger with the front flap hanging outside the seat pocket and which can organize a number of items needed during travel and which further can be easily removed as a single package when disembarking from an airline, train, bus or other vehicles.

In one aspect, the invention is directed to a travel bag comprising a front panel pivotally connected to a rear panel wherein the front panel and the rear panel are further connected by side connectors to define an interior space with a top opening; a front flap comprising an inner face and an outer face secured to said rear panel by a flexible connection for pivotal movement relative thereto; an internal pocket in said front flap comprising an inner face opening in the inner face of the front flap near the flexible connection; wherein in a closed position the front flap is rotated over the front panel to close the travel bag exposing the outer face of the front flap, and wherein in an open position the front flap is rotated over the rear panel to open the travel bag exposing the inner face of the front flap.

The side connectors can be attached to the front panel and back panels by any suitable permanent means such as an integral connection, sewing, rivets or gluing, and optionally can be removably attached by suitable conventional means such as snap fasteners, buckles, hook-and-loop material, zippers, buttons, combinations and the like.

The front flap of the travel bag has an inner face which has an inner face opening. The inner face opening may be any opening such as a slit and the opening may be parallel to the flexible connection. See, e.g., FIGS. 1, 2 and 5. The opening may be reinforced and/or may be a reclosable opening. A reclosable opening may comprise, for example, any suitable closures such as snaps, buttons, zippers and hook and loop (e.g., VELCRO) type fasteners and the like. The inner face opening leads to the internal pocket in the front flap. When the travel bag is in the open position, with the front flap in engagement with or adjacent to the rear panel, the opening to the internal pocket in the front flap is accessible from the outside. In other words, the internal pocket is an upward opening internal pocket when the travel bag is in such an open position. When the travel bag is in a closed position with the front flap in engagement with or adjacent to the front panel, any content in the internal pocket is protected against spillage because the inner face opening is not exposed.

The travel bag, including the front panel, the rear panel, and/or the front flap can be constructed of any of a number of suitable flexible materials such as leather, imitation leather, plastic, cloths of various kinds in single or multiple layers. The flexible material may be selected from woven and nonwoven fabrics of natural and synthetic fibers and can include cushioning material. In addition, the flexible material may comprise one or more layers of stiffening members such as foam, synthetic sheets, wood or a composite material. As an example, the front panel, the rear panel and/or the front flap may be stiffened. A stiffening member may be used under a fabric cover material to construct the travel bag. A semi-rigid stiffening material, if used, gives the travel bag a basic form, aiding appearance and function and in offering protection to items stored in the travel bag.

In one aspect, the interior pocket in the front flap may comprise one contiguous compartment. As an example, the interior pocket can comprise the complete interior of the front flap. In another aspect, the interior pocket may be divided into subcompartments as shown in broken lines in FIG. 1 for holding smaller items such as pens, glasses, pills, cell phones, and the like. These subcompartments may be formed by providing closure or sewing lines into the front flap or may be formed by fixed or removable dividers within the interior pocket. Fixed dividers may be, for example, attached or sewn into the front flap. Removable dividers may be, for example, held by hook and loop fasteners attached to the dividers and an interior wall of the interior pocket. In one aspect, the front flap may comprise an interior surface and an exterior surface connected by front flap side connectors thereby defining an interior space with an opening which is the inner face opening.

The travel bag may comprise a suitable fastener such as a snap, button or hook and loop fastener for keeping the travel bag in a closed position. For example one part of a snap may be on the front flap and the second part of a snap may be on the front panel such that, when the travel bag is in a closed position, the parts of the snap are connected to keep the travel bag in the closed position.

The travel bag, in a closed position, preferably is dimensioned to fit inside a passenger seat back pocket of a vehicle such as a plane, a bus, a train, a ferry or the like. See, e.g., FIG. 4. In another aspect, the travel bag, in an open position, is constructed to have the front panel and rear panel fit inside the seat back pocket of a vehicle while the front flap is moved outside the seat back pocket. See, e.g., FIG. 5. In this position, the contents of the internal pocket in the front flap and the contents of the interior space, defined by the front flap inner face and outer face are accessible.

These and other objects, advantages, and features of the invention will be set forth in the detailed description which follows.

### BRIEF DESCRIPTION OF THE DRAWINGS

FIG. 1 is a front elevational view of a travel bag, in an embodiment of the present invention, in a closed position with the front flap rotated over the front panel;

FIG. 2 is a front elevational view of the travel bag of FIG. 1, with the front flap rotated upwardly away from the front panel and the back panel;

FIG. 3 is a side elevational view of the travel bag in the closed position of FIG. 1;

FIG. 4 is an elevational view of the travel bag positioned in a seat pocket in a closed position with the rear panel facing outwardly; and

FIG. 5 is an elevational view similar to FIG. 4 showing the travel bag positioned in the seat pocket in an open position with the front flap extending over the rear panel and positioned outside the seat pocket exposing the opening in the inner face of the front flap.

### DETAILED DESCRIPTION OF THE PREFERRED EMBODIMENTS

It should be understood that the following description of the presently preferred embodiments of the present invention is merely representative of many possible embodiments and thus is not intended to limit the scope of the present invention.

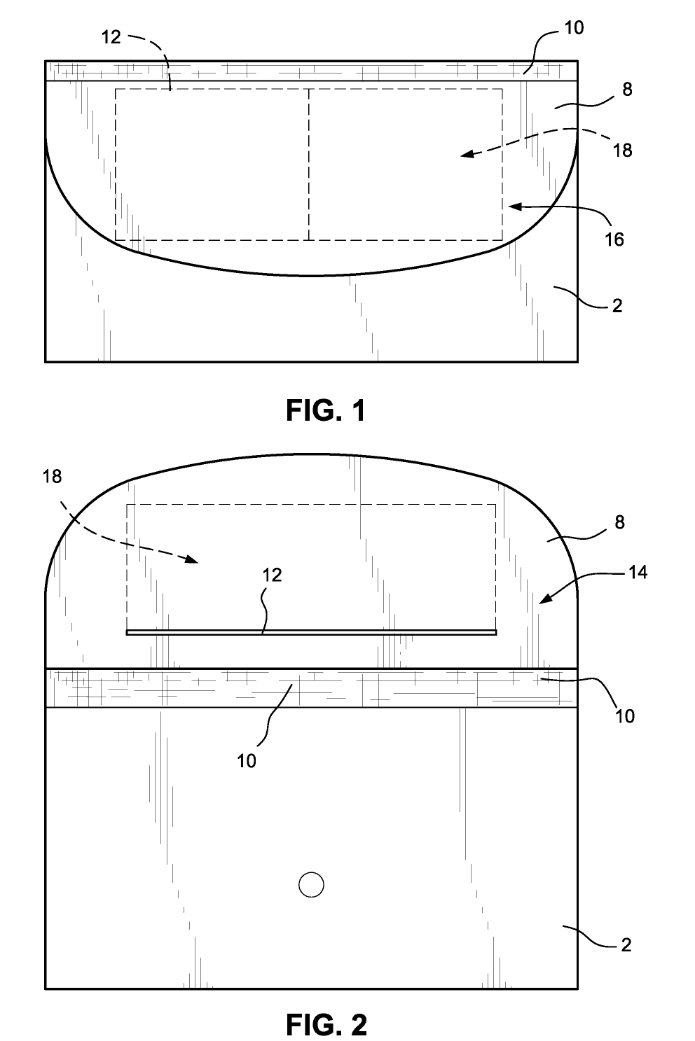

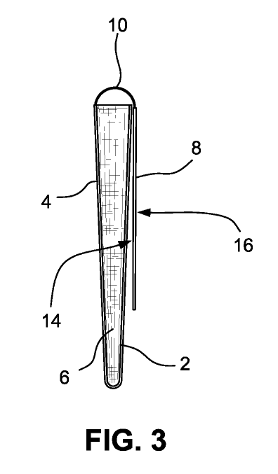

As shown in FIGS. 1-5 of the drawings, the travel bag of the present invention may be formed of any suitable material such as leather, imitation leather, plastic, fabric or the like. The bag generally comprises a front panel 2 that is connected in any suitable manner to a rear panel 4 on the sides thereof by any suitable flexible connection 6 as shown in FIG. 3 to define an internal space therebetween. The connection 6 may be integral and formed of a material that yields elastically to accommodate large or bulky items stored in the internal space, and may be a fixed or removable connection.

FIGS. 1 and 3 show the travel bag in a closed position. A front flap 8 comprising an inner face 14 and an outer face 16 is pivotally connected to the rear panel 4 by a suitable flexible connection 10 that may be integral and formed of a suitable material or fabric such that the front flap 8 can be rotated over the front panel 2 to close the bag (FIGS. 1 and 3) or rotated over the rear panel 4 to an open position in a manner to be described more fully hereinafter. In the closed position, the outer face 16 of the front flap 8 is exposed. In an open position, as shown in FIG. 5, the inner face 14 of the front flap 8 is exposed.

FIGS. 1, 2 and 5 show in broken lines an internal pocket 18 in the front flap 8 with a wide opening 12 located near the flexible connection 10 with the rear panel 4. The wide opening 12 is exposed when the front flap 8 is folded over the rear panel 4 so that the internal pocket 12 in the inner face 14 of front flap 8 can be accessed. The internal pocket may be formed of one or more compartments, as shown in FIG. 1. In an embodiment, the wide opening 12 is near and substantially parallel to the flexible connection 10. In another embodiment, the wide opening 12 may be a reclosable opening incorporating, for example, a zipper, button, or a fastener.

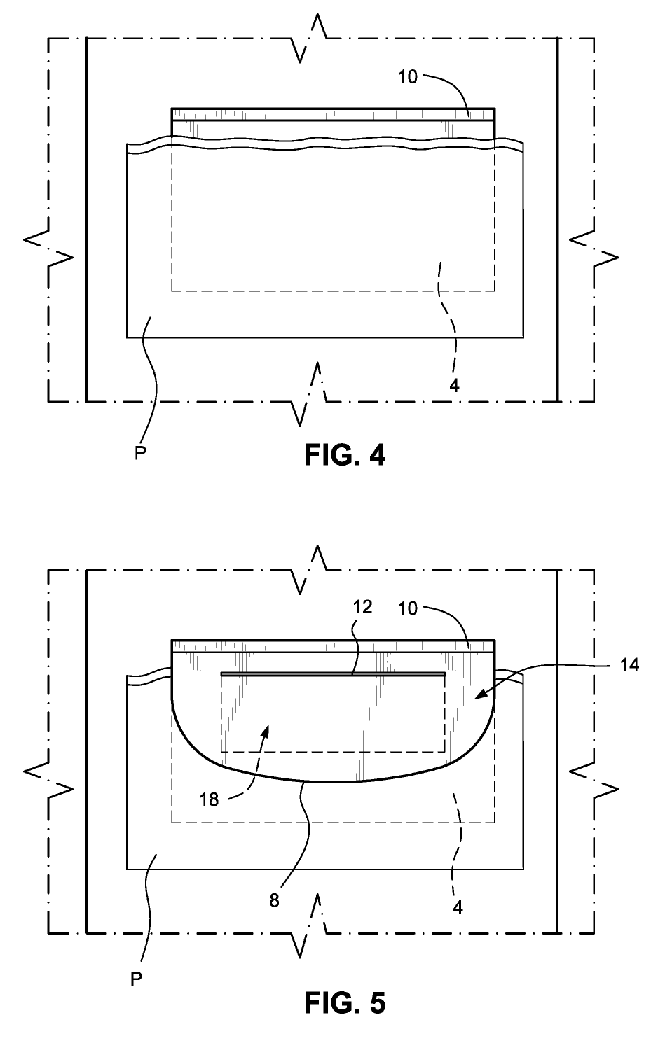

FIGS. 1, 3 and 4 show the travel bag in the closed position wherein the travel bag can be positioned in a passenger seat pocket P in the rear of an airline or train seat or the like with the rear panel 4 thereof facing outwardly or rearwardly (see, e.g., FIG. 4).

FIG. 5 shows the travel bag in an open position. In this position, the front flap 8 is rotated over the rear panel 4 to position and support the front flap 8 over the seat pocket P and to expose the inner face 14 and the opening 12 to the internal pocket 18 in the front flap 8 so that it can be accessed by a passenger behind the seat. In this open position, the internal pocket 18 has the opening 12 on top.

I claim:

1. A travel bag comprising:
a front panel connected to a rear panel by side connections to define an interior space therebetween with a top opening;
a front flap secured to said rear panel near the top opening by a flexible connection for pivotal movement relative thereto;
said front flap comprising an inner face and an outer face defining an internal pocket therebetween;
the inner face of the front flap having an opening into the internal pocket;
wherein the front flap is movable to a closed position over the front panel to close the travel bag and expose the outer face of the front flap, and
wherein the front flap is movable to an open position over the rear panel to open the travel bag and expose the inner face of the front flap and the opening into the internal pocket.

2. The travel bag of claim 1 being constructed to fit within a seat pocket in the rear of a passenger seat so that in the open position the front flap is positioned over the seat pocket so that the opening into the internal pocket in the inner face of the front flap can be accessed by a person positioned behind the passenger seat.

3. The travel bag of claim 1 wherein the side connections are flexible.

4. The travel bag of claim 1 wherein the inner face opening into the internal pocket is an elongated slit that is near the flexible connection.

5. The travel bag of claim 1 wherein the inner face opening is a reclosable opening.

6. The travel bag of claim 5 wherein the reclosable opening comprises a snap, a zipper, button, or a hook and loop fastener.

7. The travel bag of claim 1 wherein the opening into the internal pocket is an upward opening when the front flap is in the open position.

8. The travel bag of claim 1 wherein the front panel, rear panel and front flap are formed of flexible material.

9. The travel bag of claim 1 wherein the internal pocket comprises a plurality of compartments.

10. The travel bag of claim 1 further comprising a fastener for removably retaining the front flap in a closed position over the front panel.
